(19) United States
(12) Patent Application Publication
(10) Pub. No.: US 2008/0061714 A1
(43) Pub. Date: Mar. 13, 2008

(54) Switch control system of HomePlug and method thereof

(76) Inventors: Wei-Hao Syu, Taipei City (TW); Chin-Fu Tsao, Sanchong City (TW); Cheng-Ru Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/500,385

(22) Filed: Aug. 8, 2006

(51) Int. Cl. H05B 37/02

(52) U.S. Cl. 315/294

(57) ABSTRACT

A switch control system of HomePlug and method thereof are disclosed. At least a switch and a central server are connected to form a home network. By a switch identification number composed of a Medium Access Control Address (MAC address) of the switch and a server identification (ID), the central server identifies the status of each switch. By a power line, the central server connects with the switch for data transmission and switching the status of the switch. By the server ID, the switch is not affected by interference from other controller.

### BACKGROUND OF THE INVENTION

The present invention relates to a power line home network, especially to a switch control system of HomePlug and method thereof.

Nowadays information and electronics industries have been highly developed, especially the home network in recent years. Miscellaneous high-tech appliances have been used by each family. Thus there are more and more switches for control of those electronics. It is an important issue to control these switches effectively and conveniently.

Refer to FIG. 1, it shows a schematic drawing of a control system for a local area network. A first switch 1′, a second switch 2′, and a third switch 3′, all having network function, are connected with a central server 4′ for control above switches to form a local area network. A Medium Access Control Layer (MAC Layer) of the switch is used for packets delivery inside the local area network.

However, once a controller is disposed inside the local area network, if the switch is unable to identify the central server 4′, it may be interfered with by the controller. Moreover, the central server 4′ may also get problems in controlling the first switch 1′, the second switch 2′, and the third switch 3′ well. Furthermore, there are miscellaneous hi-tech appliances used at home. In order to set up a local area network, lots of network cables are used for connecting each appliance. This not only increases the cost but also leads to a poor appearance.

There is a need to improve above shortcomings of conventional control system. In order to control each switch effectively and conveniently, a switch identifying number composed of a Medium Access Control Address of each switch and a server ID of a central server is used. Moreover, by means of HomePlug network standard, the network cables are no more used. Thus the cost is saved.

### SUMMARY OF THE INVENTION

It is therefore a primary object of the present invention to provide a switch control system of HomePlug and method thereof that prevent interference from other controllers by a server ID saved in a switch.

It is another object of the present invention to provide a switch control system of HomePlug and method thereof that use a switch identification number composed of a Medium Access Control Address of the switch and a server ID of a central server so as to make the central server control each of the switches with unique identification number.

It is a further object of the present invention to provide a switch control system of HomePlug and method thereof that connect switches of appliances by HomePlug specification. Without dedicated network cables for connectivity, both cost and space are saved.

It is a further object of the present invention to provide a switch control system of HomePlug and method thereof that control different switches by the central server. There is no need to use a lot of controllers for each of the switches. Thus the convenience of use is improved.

In order to achieve objects and advantages, the present invention uses at least one switch and a central server, both having network function. The network device must have a physical location that is also referred to as the MAC address, plus a server ID of the central server to from a switch identification number. Through the switch identification number, the central server learns status of the switch and further switches the status so as to prevent control error. The switches identifies whether the server is a set controller by the written-in server ID so as to avoid interference from other controllers. Furthermore, the structure of the present invention is base on HomePlug specification so that dedicated network cables are saved and the cost is down. The beauty of interior design is also not affected. In addition, only one central server can control each of the switches. Thus the convenience of use is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing a conventional local area network control system;

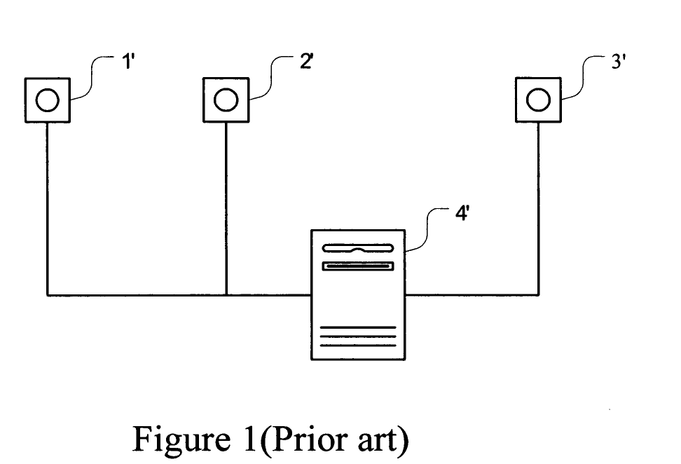

FIG. 2 is a switch control flow chart of an embodiment of HomePlug according to the present invention;

FIG. 3 is a block diagram of a switch control system of HomePlug according to the present invention;

FIG. 4 is a block diagram of another embodiment of HomePlug according to the present invention;

FIG. 5 is a schematic drawing of a switch control system of HomePlug according to the present invention.

### DETAILED DESCRIPTION OF THE PREFERRED EMBODIMENT

Without server IDs, controllers can't be identified correctly by conventional local area network control system and easy to be interfered with by other controllers. Moreover, each switch can't be effectively managed by the server. Furthermore, conventional local area network control system uses a lot of network cables for connection. This not only needs a lot of space for distribution but also increase cost. Therefore, the present invention provides a switch control system and method thereof base on HomePlug technology for improving above shortcomings.

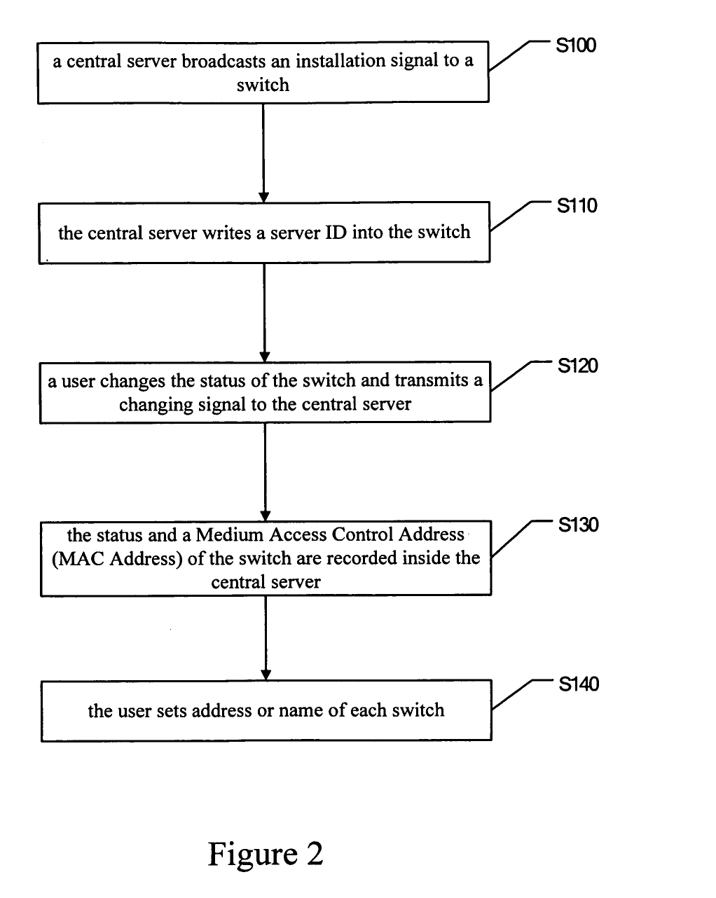

Refer to FIG. 2, firstly, take the step S100—a central server broadcasts an installation signal to a switch. For control of the switch, the switch needs to be set in advance. The central server sends an installation signal to a switch located on the same circuitry. Then run the step S110, the central server writes a server ID into the switch. While sending the installation signal to a switch, the server writes the server ID at the same time simultaneously. Later the switch enters a set mode. Then take the step S120, a user changes the status of the switch and transmits a changing signal to the central server. After the switch entering the set mode, the status of the switch needs to be changed and a related changing signal is sent to the central server so as to make the central server learn the status of the switch. Refer to step S130, the status and a Medium Access Control Address (MAC Address) of the switch are recorded inside the central server. Because the switch has the network function and every network device has the MAC Address, the server records the status of the switch and the MAC Address after receiving the changing signal from the switch. The MAC Address is saved into a list for sending information to the switch. At last, take the step S140, the user sets address or name of each switch. After finishing above steps, the system informs the user to give address or name of each switch for controlling each of the switches directly by the set name.

In each step above-mentioned, the central server uses the MAC Address plus the ID server as a switch identification number for identifying different switches. By the sever ID, the switch avoids interference from other controller. Moreover, after finishing the setting, once there is a new switch added into the home network, it is necessary to run above steps again for setting the new switch.

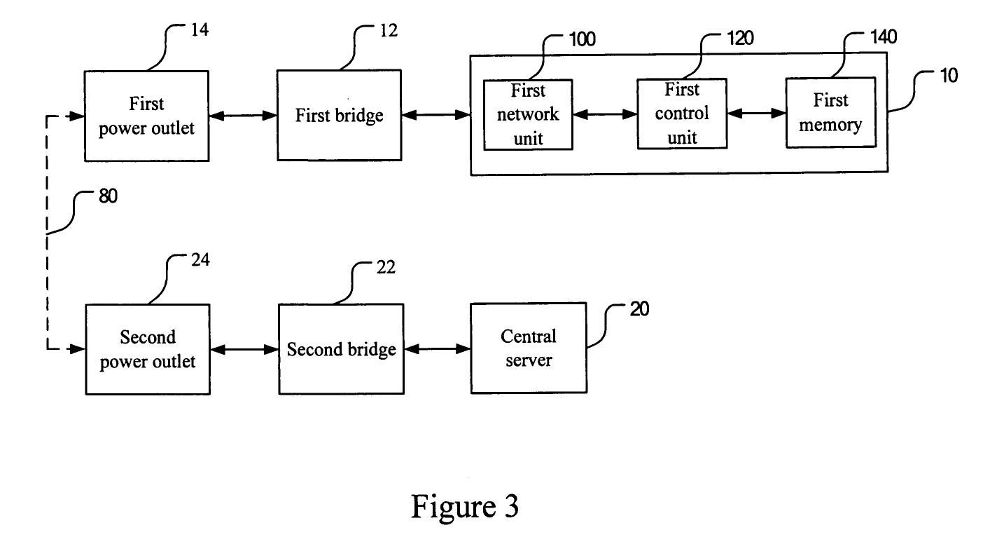

Refer to FIG. 3, a home network according to the present invention is set based on HomePlug and is composed of a first switch 10 connected with a first bridge 12, the first bridge 12 connected with a first power outlet 14, a central server 20 connected with a second bridge 22, the second bridge 22 connected with a second power outlet 24, and a power line 80 connecting the first power outlet 14 with the second power outlet 24. The first switch 10 consists of a first network unit 100, a first control unit 120 connected with the first network unit 100, and a first memory 140 connected with the first control unit 120. While setting for control of the first switch 10, the central server 20 sends an installation signal to the first network unit 100 of the first switch 10 through the second bridge 22 and the power line 80. The installation signal includes a server ID. The first control unit 100 of the first switch 10 saves the server ID inside the first memory 140 and enters a set mode. Next the user changes the status of the first switch 10 and transmits a changing signal to the central server 20. After receiving the changing signal, the central server 20 records the status of first switch 10 and also its MAC address. Then the user give the first switch 10 a name or an address so that he/she can choose the switch directly through the set name or address for improving the convenience of operation. Due to the server ID of the central server 20 saved inside the first switch 10, interference from other controllers is not affected. Furthermore, the central server 20 can send information to the first control unit 120 of the first switch 10 by means of the power line 80 for switching the status of the first switch 10.

In addition, the bridge 12, 22 can convert power signal to data signal or convert data signal to power signal. Furthermore, the bridge 12, 22 is individually disposed a plug and the plug is connected with the power outlet 14, 24.

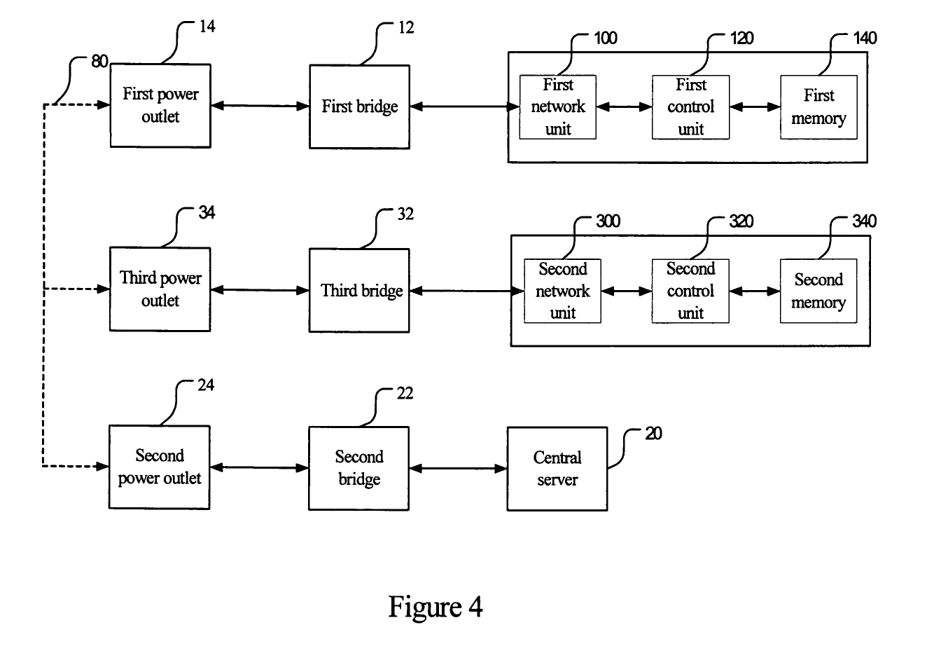

Refer to FIG. 4, another embodiment of the present invention is revealed. This embodiment includes one more set of switch. A second switch 30 connects with a third bridge 32 and a power line 80 of a home power outlet is used as a transmission medium for each other. The first bridge 12 connects to a first power outlet 14, the second bridge 22 connects to a second power outlet 24, and the third bridge 32 connects to a third power outlet 34. Before adding the second switch 30, it is necessary to set the device as mentioned above. The central server 20 identifies the first switch 10 and the second switch 30 by a switch identification number composed of the record of the MAC address of the first switch 10 as well as the second switch 30 and the server ID of the central server 20. Furthermore, the wire for connecting the first switch 10, the second switch 30 and the central server 20 can be RJ-45 cable or USB cable for convenience of use.

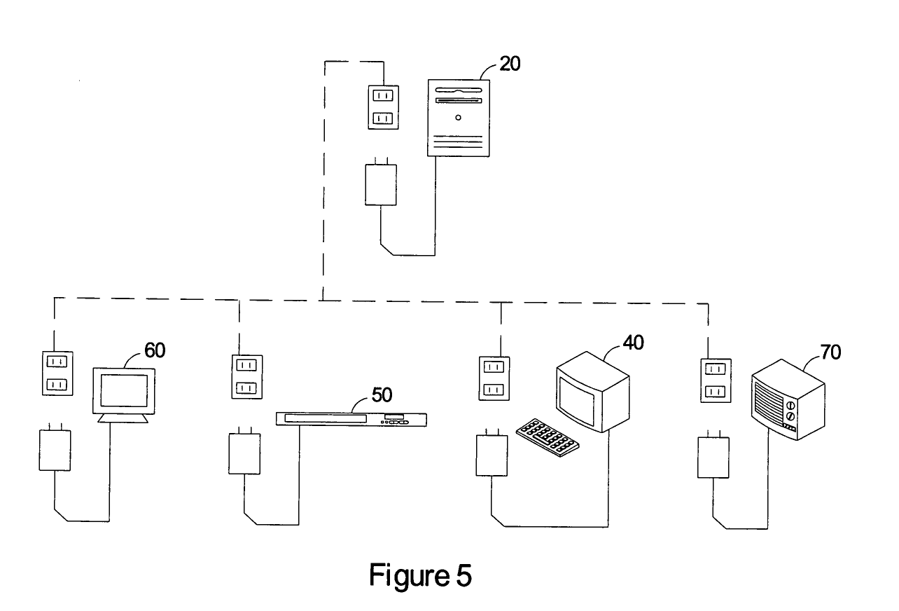

Refer to FIG. 5, a home network connecting a central server 20, a digital television 60, a DVD recorder 50, a computer 40 and an air-conditioner 70 is formed based on a Home Plug network standard. The digital television 60 and the DVD recorder 50 are internet appliances. While connecting the home network, a switch is set. The switch disposes each device in the home network. The central server 20 identifies the locations of the switches of the computer 40, the DVD recorder 50, the digital television 60, the air-conditioner 70 and learns status of the switches by the MAC address of each internet appliance as well as a server ID. Furthermore, a power line is used to send information for switching the digital television 60, the DVD recorder 50, and the computer 40. Users can monitor on/off status of the computer 40, the DVD recorder 50, the digital television 60, the air-conditioner 70 by means of the central server 20. Once the power of the digital television 60 is on without being used, the power is turned off by the central server 20 for saving energy. When the user is watching the digital television 60, he/she can turn on the DVD recorder 50 through the central server 20 if he/she wants to watch DVD. Or if the weather is too hot, the air-conditioner 70 is turned on by the central server 20. Therefore a plurality of switches are controlled by the central server 20 and it is unnecessary to set a controller on each switch so as to achieve the convenience for use. Moreover, the switch saves the server ID of the server 20 so that interference from controller is prevented. Furthermore, there is no need to use a lot of network cables due to HomePlug technology. Thus the cost is saved and the interior decoration is not affected by dedicated network cables.

In summary, the present invention uses HomePlug specifications to connect internet appliances to each other as well as a central server as an on/off controller through the power lines in a home. Bridges are also necessary for performing format conversion of information or power. Each of the internet appliances has a MAC address, plus a server ID so as to enable the central server identifying status of different switches and switching. Moreover, a memory of internet appliance saves the server ID of the central server so as to prevent interference from other controller. Furthermore, the internet appliances at home are controlled only by the central server. Thus it is convenient and easy to use. Because the HomePlug uses available electrical wires and power lines to build up the home networks, there is no need to add new wires so that the cost is down. Without dedicated network cables, the beauty of interior design will not be destroyed.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A switch control method of HomePlug comprising the steps of:
broadcasting an installation signal to a switch by a central server;
writing a server ID into the switch by the central server;
changing status of the switch by a user and sending a changing signal to the central server by the switch;
recording the status and a Medium Access Control Address (MAC Address) of the switch inside the central server; and
setting address or name of the switch by the user;
wherein the central server identifies the switch through a switch identification number having the MAC Address and the server ID of the switch and switches the switch by a power line.

2. The method as claim in claim 1, wherein before the step of changing status of the switch by a user, the method further comprising a step of:
enabling the switch entering a set mode.

3. The method as claim in claim 1, wherein a new switch is set up while being added into the home network.

4. The method as claim in claim 1, wherein the central server sends signals to the switch by means of the Medium Access Control Address for controlling the switch.

5. The method as claim in claim 1, wherein different switch having different Medium Access Control Address.

6. The method as claim in claim 1, wherein the central server records the Medium Access Control Address of each switch into a list.

7. A switch control system of HomePlug comprising:
a first switch connected with a first bridge and having
a first network unit,
a first control unit connected with the first network unit for control of the first switch,
and a first memory connected with the first control unit;
and a central server connected with a second bridge that connects with the first bridge by a power line for controlling the first switch.

8. The system as claimed in claim 7, wherein the first network unit of the first switch having a Medium Access Control Address (MAC Address).

9. The system as claimed in claim 8, wherein the network unit of different switches having different Medium Access Control Address.

10. The system as claimed in claim 7, wherein the central server having a server ID.

11. The system as claimed in claim 7, wherein a home network is formed through connection of the bridge.

12. The system as claimed in claim 7, wherein a wire for connecting with the central server and the first switch is a RJ-45 cable or a USB cable.

13. The system as claimed in claim 7, wherein the first switch is an internet appliance.
